(19) United States
(12) Patent Application Publication
(10) Pub. No.: US 2010/0147194 A1
(43) Pub. Date: Jun. 17, 2010

(54) Formulation for Obtaining a Fibre-Reinforced Concrete Mixture with High Mechanical Strength and Low Volume Weight

(75) Inventors: Sergio Omar Galván Cázares, Mexico City (MX); Joel Sosa Gutiérrez, Mexico City (MX)

Correspondence Address: JOHN F. LETCHFORD, ARCHER & GREINER, P.C., ONE CENENNIAL SQUARE, HADDONFIELD, NJ, 08033, US

(73) Assignee: Concretos Translucidos, S. de R.L. de C.V., Col. Guadalupe Inn (MX)

(21) Appl. No.: 12/083,667

(22) PCT Filed: Oct. 17, 2006
(86) PCT No.: PCT/MX2006/000110

§ 371 Date: Apr. 16, 2008

(30) Foreign Application Priority Data
Oct. 17, 2005 (MX) PA/A/2005/011138

(51) Int. Cl. C04B 7/00

(52) U.S. Cl. 106/638

(57) ABSTRACT

A method of obtaining a fibre-reinforced concrete with high strength and low volume weight. The concrete mixture has greater mechanical strength properties than those of a standard concrete and a lower volume weight. The invention comprises a matrix of cement, water and fibres, preferably glass-fibre waste, to reinforce the stone aggregates. The formulation comprises a type of concrete that is different from those currently available, owing to the formulation, mixture and novel mechanical behaviour thereof.

### FIELD OF THE INVENTION

The present invention relates to an additive for cement that permits a concrete to be obtained with high mechanical resistance and low volumetric weight, which is achieved by means of adding glass fibres coated in resin and other additives.

### PRIOR ART OF THE INVENTION

The concretes traditionally used in the construction industry currently generally consist of cement, water, coarse aggregate (gravel), fine aggregate (sand) and some additive if it is wished to increase any of their properties such as is workability, resistance, setting time, etc.

In order to carry out constructions, the study of composite materials for construction is currently one of the overriding necessities, as a means for obtaining substitutes for various materials which are nowadays scarce and expensive.

The mechanical properties of traditional concretes are reduced in line with their resistance and volumetric weight.

### DESCRIPTION OF THE INVENTION

The main object of this invention is to show the formulation for obtaining a fibre-reinforced concrete with mechanical properties superior to those of a traditional concrete, which, as well as having a lower volumetric weight, is formulated on the basis of cement, water and fibreglass waste, which are used as ultralight aggregates for reinforcement.

The formulation of the concrete forming the object of this present invention consists of a mixture of cement, water and aggregates (fine and coarse) in order to obtain a rocky material with mechanical characteristics to compression, bending, torsion, etc. and physical characteristics similar to rock. In order to manufacture the concrete forming the inventive object, a matrix or binder was chosen, based on water and cement; the cement used was Portland type cement, preferably white.

In the formulation of this concrete fibreglass waste has been used coated with a resin for reinforcement of the aggregates, in order to reduce the volumetric weight and increase the mechanical resistance, homogenised prior to use, in order to guarantee a good distribution of these ultralight aggregates in the concrete paste.

The fibreglass waste has to be coated in resin, whether this be polyester, epoxy or any polyurethane and, in general, any resin, aiming for at least a 50% coating of its surface with the resin. The procedure for this can be any kind, such as laminating, extrusion and even polishing/extrusion. The aspect ratio of the fibreglass waste (i.e., the ratio of the diameter versus the length of the fibres) should be between 0.05 and 0.9, preferably between 0.25 and 0.5. As an example of fibreglass waste coated in resin, one can use ground fibre from fibreglass trimmings coated in polyester resin, with a real density of 2.7, and a melting point higher than 1700° C. The manufacturing process is by laminating, following a process of spraying with a spray-gun. The average length of the fibres is 1.89 centimetres. The volumetric weight of the fibre is 215 kg/m3.

The physical and chemical characteristics of the fibreglass waste to be used are: high fibre-matrix adherence (in this case the matrix is cement), electrical characteristics (electrical insulator), dimensional stability, non-combustibility, mechanical resistance (Traction/Density specific resistance greater than for steel), suitability for receiving different wettings, non-rotting, low thermal conductivity and excessive flexibility.

The constituents of the fibreglass waste are 65% SiO2; 4% Al2O3; 5.5% B2O; 14% CaO; 3% MgO; 8% K2O and 0.5% Na2O.

The content of cement is that used in structural applications and with a W/C (water/cement) ratio ranging from 0.05 to 0.7, the optimum being between 0.2 and 0.54, in order to obtain a good workability without using any other kind of aggregate or additive. The setting method was for 28 days with a relative humidity of 30%.

The water/cement ratio and other ratios have to comply with the following equations depending on the design resistance (F′c) required.

The first equation (a) establishes the W/C (water/cement) ratio for a certain required design or mechanical resistance (F′c). The variable a refers to the W/C (water/cement) ratio to be used in the formulation of the concrete forming the object of this invention. This equation can be useful if it is wished to learn the resistance which a given W/C (water/cement) ratio can have according to this formulation, or otherwise, if it is wished to know what the necessary W/C (water/cement) ratio is for a certain required mechanical resistance (F′c).

F′c=4999.78261811 a⁴−13224.787328 a³+13559.8887004 a²−6968.83294926 a+1767.98787878 a)

F′c=−200000000 c³+100000000 c²−200000000 c+100000000 b)

F′c=−292.91 s³+1130.1 s²−1418.9 s+727.11 c)

F′c=−184.7 f³+391.45 f²−229.97 f+169.23 d)

The second equation (b) establishes the ratio which the Water/Cementing materials have to comply with, where the quantity of cementing materials results from the sum of all elements having a pozzolanic or cementing reaction, and can even harden by means of a hydraulic process, as with cement. These elements can be sands with granulometries that pass through a 350 sieve, as well as all those granular elements with a pozzolanic reaction on the concrete. The variable c represents the Water/Cementing materials ratio.

The third equation (c) establishes the ratio which the Sand/Cement has to comply with, where the quantity of sand to consider will be just that which fails to pass through a 300 sieve, the nature and origin of the sand being of no importance. The variable s represents the Sand/Cement ratio.

The fourth equation (d) establishes the optimum ratio which the Fibre/Cement has to comply with, where the quantity of fibre to consider will be the sum of all the fibres used in the concrete, the nature and origin of the fibre being of no importance. The variable f represents the Fibre/Cement ratio.

The proportions of fibres used for the formulation of the concrete, according to the equations (a), (b), (c) and (d), the object of the invention, range from a fibre content of 0.5% by weight of cement, which provides an average compression resistance of 280 MPa and an increase in resistance to shear of approximately 64% compared with that of a normal concrete, up to a fibre content of 40% by weight of cement, which provides an average compression resistance of up to 466 MPa and an increase in resistance to shear of 92% compared with that of a normal concrete. The optimum being a fibre content of 20%, which provides an average compression resistance of 352.71 MPa and an increase in resistance to shear of approximately 84% compared with that of a normal concrete. With the cement/fibre ratios ranging from 12.94 to 1.62, the optimum being 3.24. Alternatively, use can be made of polypropylene fibres, kevlar, metallic fibres, aramide fibres, polyester fibres, textile microfibres, glass microfibres, steel fibres, sisal fibres and in general any fibre offering good mechanical behaviour.

For the mixture of the concrete forming the object of the invention, the modulus of elasticity varies between 282000 MPa for a fibre content of 5%, 333000 MPa for fibre content of 20%, and up to 372000 MPa for a fibre content of 40%.

The cement used for the formulation forming the inventive object is Portland cement, preferably of the white type, which is primarily composed of 50% tricalcic silicate, 24% dicalcic silicate, 11% tricalcic aluminate and 8% tetracalcic ferrous aluminate, with a specific weight of 3.1.

The water used in the mixing is ordinary water. In order to ensure the quality of the water, it is merely necessary to check that it has no coloration or odour.

The method of proportioning the concrete can be adapted to any of the existing methods, always provided that the stated proportions of fibre are respected, and that each of the equations (a), (b), (c) and (d) are met. Generally speaking, according to the invention, a formulation for obtaining a fibre-reinforced concrete mixture of high mechanical resistance and low volumetric weight, preferably comprises a matrix of cement-water and fibres, preferably fibreglass waste as reinforcement for the rocky aggregates; the cement being present from about 10% up to about 72% by weight by total weight of concrete, the optimum being about 63%; the water content being from about 4% up to about 37% by weight of cement, the optimum being about 25%; the fibreglass content from about 0.5% up to about 40% by weight of cement, the optimum being in a range of about 13% to about 20%.

The manufacturing process for the formulation of the concrete forming the inventive object is to homogenise the fibres with the cement, first manually, followed by mechanical homogenisation, until a perfect distribution of the fibres in the cement is obtained.

Once the cement is homogenised with the fibres, the necessary quantity of water is added constantly and mixed for the time needed to obtain a manageable mixture.

Once the mixture has been obtained, it is cast, using a compacted method, whether this be manual or mechanical.

The method of setting can be any of those permitted by current regulations on the setting of concrete, preferably 28 days with a humidity of 30%.

In accordance with the description given above, it is possible to affirm that the characteristics of mechanical resistance to compression and volumetric weight, up to 25% less, of the formulation forming the object of the invention, have not been achieved by any other traditional or known concrete. For example, concrete formed in accordance with the present invention has exhibited volumetric weight ranging from 1000 Kg/m³ up to 2400 Kg/m³, depending on the nature and percentage of fibre added to the concrete mixture.

What is claimed is:

1. A formulation for obtaining a fibre-reinforced concrete mixture of high mechanical resistance and low volumetric weight comprising a matrix of cement, water and fibres, wherein the fibres function as reinforcement for aggregates in the concrete, said formulation comprising:
cement in an amount of from about 10% up to about 72% by total weight of concrete;
water in an amount of from about 4% up to about 37% by weight of cement; and
fibres in an amount of from about 0.5% up to about 40% by weight of cement.

2. The formulation of claim 1, wherein for its formulation the following equations are satisfied:
F′c=4999.78261811 a⁴−13224.787328 a³+13559.8887004 a²−6968.83294926 a+1767.98787878 a)
F′c=−200000000 c³+100000000 c²−200000000 c+100000000 b)
F′c=−292.91 s³+1130.1 s²−1418.9 s+727.11 c)
F′c=−184.7 f³+391.45 f²−229.97 f+169.23 d)
where,
“a” represents the Water/Cement ratio to use in proportioning of the concrete for a certain mechanical resistance to compression (F′c), “c” represents the Water/Cementing Materials ratio to use in proportioning of the concrete for a certain mechanical resistance to compression (F′c), “s” represents the Sand/Cement ratio to use in proportioning of the concrete for a certain mechanical resistance to compression (F′c), and “f” represents the Fibre/Cement ratio to use in the proportioning of the concrete for a certain mechanical resistance to compression (F′c).

3. The formulation of claim 1 having an average compression resistance ranging from 280 MPa up to 466 MPa, depending on the nature and percentage of fibre added.

4. The formulation of claim 1 having a shear resistance ranging from 64% up to 92% greater than in a traditional concrete, depending on the nature and percentage of fibre added.

5. The formulation of claim 1 having an elastic modulus ranging from 282000 MPa up to 372000 MPa, depending on the nature and percentage of fibre added.

6. The formulation of claim 1 having a volumetric weight ranging from 1000 Kg/m³ up to 2400 Kg/m³, depending on the nature and percentage of fibre added.

7. The formulation of claim 1, wherein said fibres comprise fibreglass.

8. The formulation of claim 7 wherein said fibreglass is fibreglass waste.

9. The formulation of claim 7 wherein said fibreglass waste is coated in resin.

10. The formulation of claim 8 wherein said fibreglass waste has an aspect ratio of between about 0.05 and about 0.9.

11. The formulation of claim 1, wherein the optimum amount of cement is in an amount of about 63% by total weight of concrete, the optimum amount of water is in an amount of about 25% by weight of cement, and the optimum amount of fibres is in an amount of about 13% to about 20% by total weight of cement.

12. A fibre-reinforced concrete mixture of high mechanical resistance and low volumetric weight comprising a matrix of cement, water and fibres, wherein the fibres function as reinforcement for aggregates in the concrete, said matrix comprising:
cement in an amount of from about 10% up to about 72% by total weight of concrete;
water in an amount of from about 4% up to about 37% by weight of cement; and
fibres in an amount of from about 0.5% up to about 40% by weight of cement.

13. The concrete of claim 12, wherein for its formulation the following equations for the matrix are satisfied:
F′c=4999.78261811 a⁴−13224.787328 a³+13559.8887004 a²−6968.83294926 a+1767.98787878 a)
F′c=−200000000 c³+100000000 c²−200000000 c+100000000 b)
F′c=−292.91 s³+1130.1 s²−1418.9 s+727.11 c)
F′c=−184.7 f³+391.45 f²−229.97 f+169.23 d)
where,
“a” represents the Water/Cement ratio to use in proportioning of the concrete for a certain mechanical resistance to compression (F′c), “c” represents the Water/Cementing Materials ratio to use in proportioning of the concrete for a certain mechanical resistance to compression (F′c), “s” represents the Sand/Cement ratio to use in proportioning of the concrete for a certain mechanical resistance to compression (F′c), and “f” represents the Fibre/Cement ratio to use in the proportioning of the concrete for a certain mechanical resistance to compression (F′c).
